(19) United States
(12) Patent Application Publication
(10) Pub. No.: US 2017/0017552 A1
(43) Pub. Date: Jan. 19, 2017

(54) INFORMATION PROCESSING APPARATUS AND METHOD OF CONTROLLING INFORMATION PROCESSING APPARATUS

(71) Applicant: FUJITSU LIMITED, Kawasaki-shi (JP)

(72) Inventor: Kazushi Yoda, KAWASAKI (JP)

(73) Assignee: FUJITSU LIMITED, Kawasaki-shi (JP)

(21) Appl. No.: 15/161,325

(22) Filed: May 23, 2016

(30) Foreign Application Priority Data
Jul. 14, 2015 (JP) 2015-140631

(51) Int. Cl. G06F 11/14; G06F 17/30

(52) U.S. Cl. CPC G06F 11/1453; G06F 17/30088; G06F 17/30156; G06F 2201/80

(57) ABSTRACT

An update information managing unit, when specific data is updated, adds update information to the specific data, prevents a predetermined program from deleting the update information, and deletes the update information added to the specific data when a predetermined condition of the specific data is satisfied. A utilization program executing unit, when the update information is added to the specific data, performs a predetermined process on the specific data.

### CROSS-REFERENCE TO RELATED APPLICATION

This application is based upon and claims the benefit of priority of the prior Japanese Patent Application No. 2015-140631, filed on Jul. 14, 2015, the entire contents of which are incorporated herein by reference.

### FIELD

The embodiments discussed herein are related to an information processing apparatus and a method of controlling an information processing apparatus.

### BACKGROUND

In general, a program accesses a file via a file system of an operating system (OS). Hereinafter, a program using the file system will be referred to as a “utilization program”. Specifically, in an operation of reading and writing a file by the utilization program, control or data transfer is performed in order of the file system, a device driver, and a storage that is hardware, or in reverse order. The file system has a basic function of the OS to provide the utilization program with data stored in the storage or information related to the data in the form of a file that is easy to manage.

The file system manages various kinds of information indicating a state of a file and also manages attribute information, in order to manage files. Examples of the various kinds of information include a file name, an access right, a file size, and an updated date and time. The attribute information includes information indicating, for example, whether a file is read-only, an archive factor, a system file, or a hidden file.

For example, a flag of an archive attribute indicating whether a file is an archive factor is automatically set to ON by the file system when the file is generated and updated, and indicates that the file has the archive attribute. Furthermore, the utilization program can call a special command of the file system and set the archive attribute to OFF.

The utilization program using the attribute includes backup software. Incremental backup and differential backup in the backup software are a mode, in which only a file with the archive attribute set to ON is copied and a backup attribute of the copied file is set to OFF after the copy. This mode enables to copy only an updated file and reduce a backup time as compared to normal backup in which all of files are copied.

Furthermore, in recent years, it is important to ensure the security of computers, and it is indispensable to introduce antivirus software. The antivirus software is a utilization program that detects a threat against a computer by performing a scan process of comparing data read from a file with a virus pattern.

Incidentally, there is a conventional technology in which an attribute such as an updated date and time is provided to a file, the file system acquires, from a program, data and contents described in an updated date and time area in response to a record read request, and exclusive control is performed by comparing the read date and time and the updated date and time. Furthermore, as virus countermeasures, there is a conventional technology in which an updated file list indicating a newly-updated file is generated and a virus check is performed on only the file indicated in the updated file list in order to complete an examination in a short time.

Patent Literature 1: Japanese Laid-open Patent Publication No. 11-065910

Patent Literature 2: Japanese Laid-open Patent Publication No. 2011-170504

However, recently, the capacity of a storage configured with a hard disk or the like is continuously increasing, and it is not uncommon to take a few hours or longer until a scan process is completed. In this regard, the scan process uses part of the processing capacity of a computer, so that a job or an operating process, which is an original intended purpose of the computer, may be extended. Therefore, if a full scan of scanning all of files is performed in a system with a large-capacity storage, a processing speed of a utilization program that is originally expected to be performed may be reduced for a few hours or longer.

To cope with this, it may be possible to use a method of adding, to each file, an update attribute indicating that a content of the file is updated, and causing antivirus software to scan only the file with the update attribute set to ON. By using this method, it is possible to reduce a scan process time. For example, it may be possible to use the archive attribute as the update attribute.

In the method of causing the antivirus software to efficiently perform a process by using update information on a file as described above, a virus that knows a structure of the file system may manipulate the update information on a file in order to avoid a scan. Specifically, if the virus steals a privileged mode of the OS and hijacks the computer, it becomes possible to change the update attribute, and the virus may exclude a virus-infected file from targets of a scan performed by the antivirus software.

Furthermore, as another issue, it is difficult to realize the coexistence with a data backup tool. If the archive attribute is used as the update attribute, the attribute is set to OFF because of execution of backup. Therefore, it becomes difficult for the antivirus software to scan all of updated files unless the antivirus software completes the scan before the execution of the backup. As described above, in the technology for scanning only an updated file by using a file attribute, such as the archive attribute, the reliability is low and it is difficult to effectively perform a scan.

Moreover, even if the conventional technology for performing a virus check on only a file indicated in the updated file list is used, a virus may rewrite the updated file list itself and the virus may avoid a scan.

### SUMMARY

According to an aspect of an embodiment, an information processing apparatus includes: a processor and a memory, wherein the processor, when specific data is updated, adds update information to the specific data, prevents a predetermined program from deleting the update information, and deletes the update information added to the specific data when a predetermined condition of the specific data is satisfied; and, when the update information is added, performs a predetermined process on the specific data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a hardware configuration diagram of an information processing apparatus;

FIG. 2 is a diagram illustrating software that operates on the information processing apparatus and states of files;

FIG. 3 is a diagram illustrating an example of attribute information;

FIG. 4 is a block diagram of the information processing apparatus;

FIG. 5 is a diagram for explaining an overview of a differential scan;

FIG. 6 is a schematic circuit diagram of a reset instructing unit;

FIG. 7 is a schematic circuit diagram of an addition instructing unit, a table managing unit, and an update detection table;

FIG. 8 is a diagram for explaining input and output with respect to an addition instructing unit;

FIG. 9 is a diagram of a truth table of an SR latch;

FIG. 10 is a timing diagram illustrating a relationship between an update detection table and a scan;

FIG. 11A is a timing diagram when a timing of setting an update attribute flag to OFF and a scan timing are close to each other;

FIG. 11B is a timing diagram when the timing of setting the update attribute flag to OFF and the scan timing are adequately separated from each other;

FIG. 12 is a flowchart of a file management process;

FIG. 13 is a flowchart of a process at the time of updating a file;

FIG. 14 is a flowchart of an attribute read process;

FIG. 15 is a flowchart of an update information management process;

FIG. 16 is a flowchart of an attribute update process;

FIG. 17 is a flowchart of a process of setting an update attribute flag by an update information managing unit;

FIG. 18 is a flowchart of an output determination process in the SR latch;

FIG. 19 is a diagram for explaining an effect of virus detection using the information processing apparatus according to a first embodiment; and

FIG. 20 is a schematic circuit diagram of a clock generating unit according to a second embodiment.

### DESCRIPTION OF EMBODIMENTS

Preferred embodiments of the present invention will be explained with reference to accompanying drawings. The information processing apparatus and the method of controlling the information processing apparatus of the disclosed technology are not limited by the embodiments below.

### [a] First Embodiment

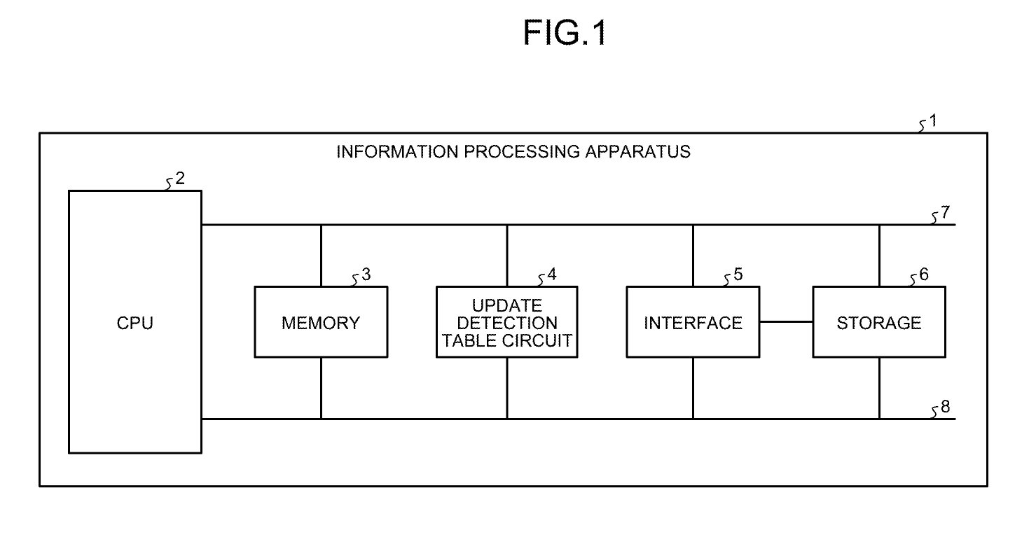

FIG. 1 is a hardware configuration diagram of an information processing apparatus. An information processing apparatus 1 according to a first embodiment includes a central processing unit (CPU) 2, a memory 3, an update detection table circuit 4, an interface 5, a storage 6, an address bus 7, and a data bus 8.

The memory 3 and the update detection table circuit 4 are connected to the CPU 2 via the address bus 7 and the data bus 8. Furthermore, the storage 6 is connected to the CPU 2 via the interface 5, the address bus 7, and the data bus 8.

The interface 5 is an interface for connecting the address bus 7 and the data bus 8 to the storage 6.

The storage 6 is a sub storage device, such as a hard disk. The storage 6 stores therein an operating system (OS). The storage 6 also stores therein various programs including a utilization program using a file system provided by the OS. As the utilization program, for example, virus detection software is stored in the storage 6. Data is written to and read from the storage 6 by various programs including the OS and the utilization program executed by the CPU 2. For example, the virus detection software reads data stored in the storage 6 and performs a virus check.

The memory 3 is a main storage device, such as a dynamic random access memory (DRAM). On the memory 3, various programs are loaded by the CPU 2 and processes are generated.

The CPU 2 reads the OS from the storage 6, loads the OS on the memory 3, and executes the OS. The CPU 2 provides a device driver and a file system by executing the OS. Furthermore, the CPU 2 reads various programs including the utilization program from the storage 6 and executes the various programs.

The CPU 2 sends and receives a to-be-used address among the memory 3, the update detection table circuit 4, and the storage 6 by using the address bus 7. Furthermore, the CPU 2 sends and receives a file among the memory 3, the update detection table circuit 4, and the storage 6 by using the data bus 8. For example, the CPU 2 writes data of a file in the memory 3, the update detection table circuit 4, and the storage 6 by sending, through the data bus 8, the data of the file to an address sent through the address bus 7. Furthermore, the CPU 2 reads, from the memory 3, the update detection table circuit 4, and the storage 6, a file to be stored at an address sent through the address bus 7. Moreover, when a file in the storage 6 is updated, the CPU 2 sets a flag of an update attribute, which indicates whether the file is updated in the update detection table circuit 4, to ON. The file for which the update attribute flag is set to ON is recognized as an updated file. This file corresponds to an example of “specific data”.

The update detection table circuit 4 is a table configured with hardware. Thus, for example, the update detection table circuit 4 is a memory element, such as an electrically erasable programmable read only memory (EEPROM).

The update detection table circuit 4 is a table for storing update information indicating whether a file stored in the storage 6 is updated, that is, whether the file has an update attribute. Specifically, the update detection table circuit 4 includes a flag of an update attribute corresponding to each file. In the following, the flag of the update attribute in the update detection table circuit 4 is referred to as an “update attribute flag”.

If the update attribute flag in the update detection table circuit 4 is set to ON, it is indicated that a corresponding file is updated. In contrast, if the update attribute flag in the update detection table circuit 4 is set to OFF, it is indicated that a corresponding file is not updated. For example, antivirus software executed by the CPU 2 acquires the update information stored in the update detection table circuit 4, scans an updated file, and detects a virus.

If a file in the storage 6 is updated, the update detection table circuit 4 receives an instruction from the CPU 2 and sets an update attribute flag corresponding to the updated file to ON. Furthermore, if a predetermined time has elapsed after the update attribute flag is set to ON, the update attribute flag in the update detection table circuit 4 is set to OFF independently of the OS. ON and OFF of the update attribute flag in the update detection table circuit 4 will be described in detail later.

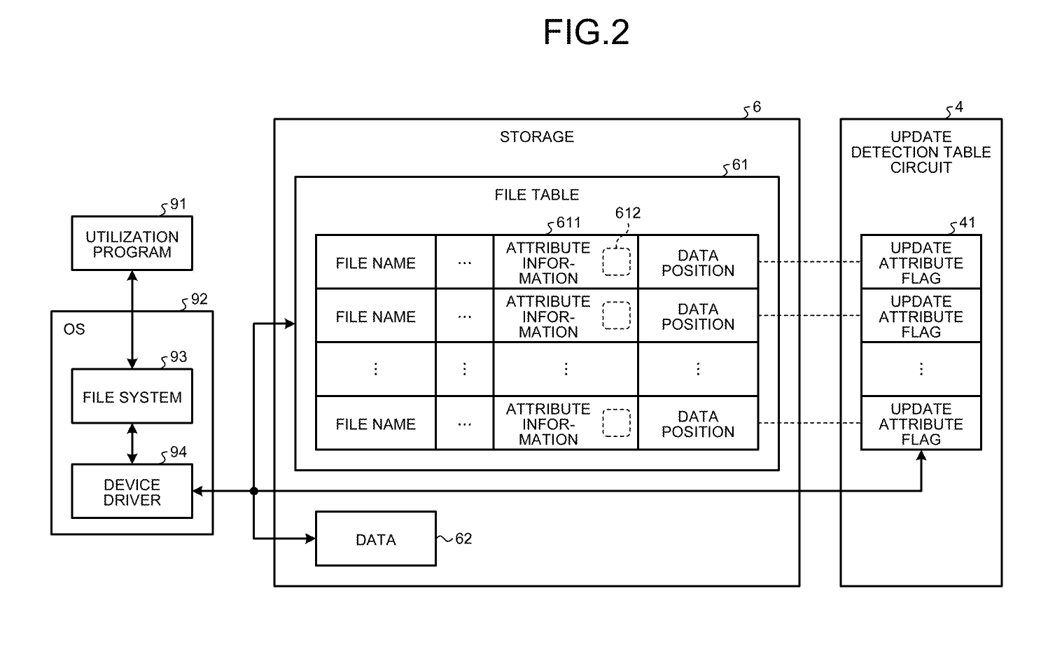

FIG. 2 is a diagram illustrating software that operates on the information processing apparatus and states of files. The storage 6 stores therein a file table 61 and data 62 of a file. A combination of information in the file table 61 and the data 62 represents a single file.

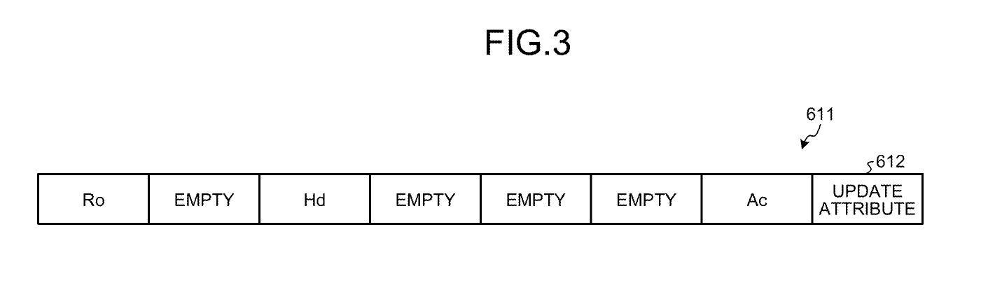

For example, a file name and a data position are stored in the file table 61. Furthermore, attribute information 611 is stored in the file table 61. The attribute information 611 is information indicating various attributes of a corresponding file. Specifically, as illustrated in FIG. 3, the attribute information 611 indicates whether a file has each attribute by using a bit value to which a flag of each attribute is assigned. FIG. 3 is a diagram illustrating an example of the attribute information.

As illustrated in FIG. 3, for example, the attribute information 611 includes a read-only (Ro) flag indicating whether a file is read-only, a hidden (Hd) flag indicating whether the file is a hidden file, and an archive (Ac) flag indicating whether the file is an archive. Furthermore, in the first embodiment, a bit 612 is ensured as a bit corresponding to the update information indicating whether a file is an updated file. As the bit 612, an empty bit of the attribute information 611 is used. For example, if the attribute information 611 contains 8 bits, and if the bit position is represented in hexadecimal notation, 0x80 is assigned to a read-only attribute. Furthermore, 0x20 is assigned to a hidden file attribute. Moreover, 0x02 is assigned to an archive attribute. The others are empty bits. Therefore, in the first embodiment, 0x01 is assigned as the bit 612 corresponding to the update attribute. Furthermore, zero is set in the other empty bits of the attribute information 611.

For example, if the Ro flag is ON, a file has the read-only attribute. Furthermore, if the Hd flag is ON, a file has the hidden file attribute. Moreover, if the Ac flag is ON, a file has the archive attribute. As for the update attribute flag, the bit 612 is only reserved, setting of ON and OFF in the attribute information 611 is inhibited, and a value of the flag is not stored in the attribute information 611.

Furthermore, the data 62 corresponding to the file name stored in the file table 61 is stored in a position indicated by the data position in the file table 61.

The update detection table circuit 4 includes an update attribute flag 41 corresponding to each file. In the first embodiment, the entry order is the same as the entry order of the file table 61. For example, if entries of the file table 61 are arranged as illustrated in FIG. 2, the update attribute flags 41 in the update detection table circuit 4 have one-to-one correspondence as indicated by dotted lines indicating the same entries in order from the top. That is, assuming that the entry number of an n-th entry from the top in the file table 61 is denoted by n, the entry number of the n-th update attribute flag 41 in the update detection table circuit 4 is denoted by n.

Furthermore, as illustrated in FIG. 2, an OS 92 operates in the information processing apparatus 1, and a file system 93 and a device driver 94 operate on the OS 92. Incidentally, the OS 92, the file system 93, and the device driver 94 are loaded on the memory 3 by the CPU 2 and generate processes. Furthermore, a utilization program 91 is also loaded on the memory 3 and operated. The utilization program 91 accesses, via the file system 93 and the device driver 94, the data 62 indicated by the data position in the file table 61 stored in the storage 6. The utilization program 91 actually accesses a file via the device driver 94; however, in the following, it is explained that the utilization program 91 directly accesses a file for convenience of description.

When updating the data 62 of a specific file, the file system 93 sets an entry of the update attribute flag 41 in the update detection table circuit 4 corresponding to an entry of the specific file in the file table 61 to ON. Furthermore, the file system 93 receives, from virus detection software that is the utilization program 91, a request to acquire the attribute information 611. Then, the file system 93 acquires the attribute information 611 and a value of the corresponding update attribute flag 41. Thereafter, the file system 93 stores the value of the update attribute flag 41 in the bit 612 of the attribute information 611, and transmits the attribute information 611 to the virus detection software that is the utilization program 91. The virus detection software as the utilization program 91 specifies an updated file from the value of the update attribute flag 41 stored in the acquired attribute information 611, and performs a virus check on the specified file.

Furthermore, the file system 93 receives an instruction from the utilization program 91, and performs a file generation process, a file deletion process, a data write process, a data read process, an attribute setting process, an attribute update process, an attribute read process, a process at the time of updating a file, and the like. The various programs executed by the CPU 2 of the information processing apparatus 1 including the utilization program 91, the OS 92, the file system 93, and the device driver 94 correspond to examples of a “predetermined program”.

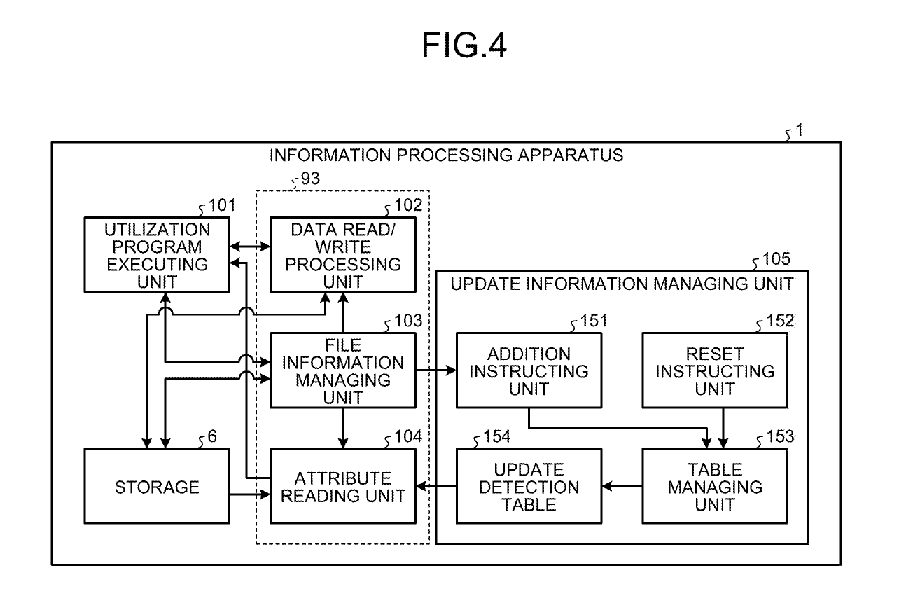

Next, each of functions of the information processing apparatus 1 will be described in detail with reference to FIG. 4. FIG. 4 is a block diagram of the information processing apparatus.

As illustrated in FIG. 4, the information processing apparatus 1 includes a utilization program executing unit 101, a data read/write processing unit 102, a file information managing unit 103, an attribute reading unit 104, and an update information managing unit 105. The data read/write processing unit 102, the file information managing unit 103, and the attribute reading unit 104 are implemented by the file system 93.

The utilization program executing unit 101 is implemented by the CPU 2 and the memory 3 illustrated in FIG. 1. Specifically, a corresponding function is implemented by an operation of the utilization program 91 illustrated in FIG. 2 executed by the CPU 2 and the memory 3.

The utilization program executing unit 101 gives an instruction to generate a file to the file information managing unit 103. Subsequently, the utilization program executing unit 101 receives an error response or a response indicating process completion from the file information managing unit 103.

Furthermore, the utilization program executing unit 101 outputs a data write instruction to the data read/write processing unit 102 and the file information managing unit 103. Moreover, in this case, the utilization program executing unit 101 instructs the file information managing unit 103 to set the update attribute flag 41 of a file, in which data is updated, to ON. Subsequently, the utilization program executing unit 101 receives an error response or a response indicating process completion from the data read/write processing unit 102 and the file information managing unit 103.

Furthermore, the utilization program executing unit 101 outputs a data read instruction to the data read/write processing unit 102 and the file information managing unit 103. Subsequently, the utilization program executing unit 101 receives an error response or the read data from the data read/write processing unit 102.

Moreover, the utilization program executing unit 101 instructs the data read/write processing unit 102 and the file information managing unit 103 to delete a file. Subsequently, the utilization program executing unit 101 receives an error response or a response indicating process completion from the data read/write processing unit 102 and the file information managing unit 103.

Furthermore, in the case of setting an attribute, the utilization program executing unit 101 outputs, to the file information managing unit 103, an attribute setting instruction including information on a file whose attribute is to be changed. Subsequently, the utilization program executing unit 101 receives an error response or a response indicating process completion from the file information managing unit 103.

Moreover, the utilization program executing unit 101 instructs the file information managing unit 103 and the attribute reading unit 104 to read an attribute. Subsequently, the utilization program executing unit 101 acquires information on the specified attribute from the attribute reading unit 104.

Operations of the utilization program executing unit 101 will be described below with a specific example in which the virus detection software as the utilization program 91 is executed. The utilization program executing unit 101 performs a full scan to perform a virus check on all of files at predetermined time intervals. For example, the utilization program executing unit 101 performs a full scan once a week. Specifically, the utilization program executing unit 101 instructs the data read/write processing unit 102 to read pieces of the data 62 of all of the files. Then, the utilization program executing unit 101 performs virus detection by scanning the pieces of the read data 62 of all of the files.

Furthermore, in addition to the full scan, the utilization program executing unit 101 performs a differential scan to scan only an updated file at predetermined time intervals more frequently than the intervals of the full scan. For example, the utilization program executing unit 101 performs the differential scan every 24 hours.

Specifically, the utilization program executing unit 101 instructs the file information managing unit 103 and the attribute reading unit 104 to read the update attribute of a file. Subsequently, the utilization program executing unit 101 acquires the update attribute of each file from the attribute reading unit 104. Then, the utilization program executing unit 101 specifies an updated file from the update attribute of each file. Subsequently, the utilization program executing unit 101 instructs the data read/write processing unit 102 and the file information managing unit 103 to read the data 62 of the specified file. Then, the utilization program executing unit 101 acquires the data 62 of the updated file from the data read/write processing unit 102. Thereafter, the utilization program executing unit 101 performs virus detection by scanning the data 62 of the updated file. The utilization program executing unit 101 corresponds to an example of a “process executing unit”.

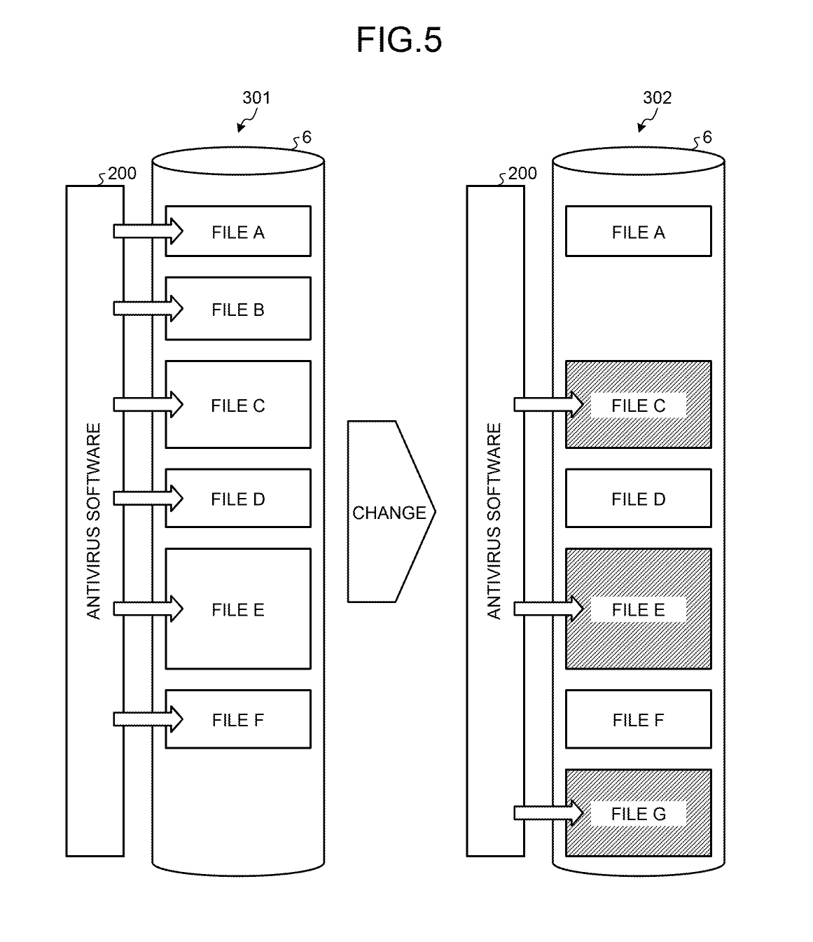

An overview of the full scan and the differential scan will be described below with reference to FIG. 5. FIG. 5 is a diagram for explaining an overview of the differential scan. A state 301 indicates a state in which the full scan is performed, and a state 302 indicates a state in which the differential scan is performed. In FIG. 5, arrows extending from antivirus software 200 to files indicate execution of scans.

As illustrated in the state 301, in the case of the full scan, the antivirus software 200 scans pieces of the data 62 of all of files A to F stored in the storage 6. In this case, a case will be described in which, after the full scan, the file B is deleted, the files C and E are updated, and a file G is newly generated. The colored files in the state 302 are updated files. In the case of the differential scan, the antivirus software 200 scans only the pieces of the data 62 of the updated files C and E and the newly-generated file G. In this manner, in the differential scan, only pieces of the data 62 of updated files including a newly-generated file are targets of a scan, so that the information processing apparatus 1 can perform the scan with a smaller load and in a shorter time than the full scan. The differential scan corresponds to an example of a “predetermined process”.

The data read/write processing unit 102 is implemented by the CPU 2 and the memory 3 illustrated in FIG. 1. Specifically, a corresponding function is implemented by an operation of the file system 93 in FIG. 2 executed by the CPU 2 and the memory 3.

The data read/write processing unit 102 receives a data write instruction from the utilization program executing unit 101. Furthermore, the data read/write processing unit 102 acquires, from the file information managing unit 103, information on a data position of the data 62 of a file to which data is to be written. Then, the data read/write processing unit 102 writes data to the data 62 located in the acquired data position in the storage 6. Thereafter, if the process is completed, the data read/write processing unit 102 sends a response indicating process completion to the utilization program executing unit 101. If an error occurs without completion of the process, the data read/write processing unit 102 sends an error response to the utilization program executing unit 101.

Furthermore, the data read/write processing unit 102 receives a data read instruction from the utilization program executing unit 101. Moreover, the data read/write processing unit 102 acquires, from the file information managing unit 103, information on a data position of the data 62 of a file from which data is to be read. Then, the data read/write processing unit 102 reads the data 62 of a specified file from the acquired data position in the storage 6. Thereafter, the data read/write processing unit 102 sends the read data 62 to the utilization program executing unit 101. If an error occurs without completion of the process, the data read/write processing unit 102 sends an error response to the utilization program executing unit 101.

Furthermore, the data read/write processing unit 102 receives a file deletion instruction from the utilization program executing unit 101. Moreover, the data read/write processing unit 102 acquires, from the file information managing unit 103, information on a data position of the data 62 of a file to be deleted. Then, the data read/write processing unit 102 deletes data stored in the acquired data position in the storage 6. Thereafter, if the process is completed, the data read/write processing unit 102 sends a response indicating process completion to the utilization program executing unit 101. If an error occurs without completion of the process, the data read/write processing unit 102 sends an error response to the utilization program executing unit 101.

The file information managing unit 103 is implemented by the CPU 2 and the memory 3 illustrated in FIG. 1. Specifically, a corresponding function is implemented by operations of the file system 93 and the device driver 94 in FIG. 2 executed by the CPU 2 and the memory 3. The file information managing unit 103 manages the file table 61 including setting and changing an attribute of each file. A process performed by the file information managing unit 103 will be described in detail below.

The file information managing unit 103 receives, from the utilization program executing unit 101, an attribute setting instruction including identification information on a file. However, the update attribute flag 41 is automatically set to ON when a file is updated and is automatically set to OFF after a lapse of a predetermined time. Therefore, the attribute setting instruction received by the file information managing unit 103 does not include explicit specification of ON or OFF of the update attribute flag 41.

Subsequently, the file information managing unit 103 specifies an entry number corresponding to the identification information on a specified file from the file table 61. Then, the file information managing unit 103 sets the attribute information 611 in the specified entry in the file table 61. Specifically, the file information managing unit 103 sets ON or OFF of a flag of a specified attribute in the attribute information 611 to a specified value. Thereafter, the file information managing unit 103 outputs a response indicating setting completion to the utilization program executing unit 101.

Furthermore, the file information managing unit 103 receives a file generation instruction from the utilization program executing unit 101. Then, the file information managing unit 103 specifies an empty entry in the file table 61. If the empty entry is present, the file information managing unit 103 registers an identifier or the like of a file in the specified entry. The file information managing unit 103 sets attribute information other than an update attribute of a generated file. The file information managing unit 103 outputs, to an addition instructing unit 151 of the update information managing unit 105, the entry number of the entry for which a file is newly generated, information on write data, and a write enable signal. The write data herein is data for setting the update attribute flag 41 to ON, and has a value of “1”, that is, a value of High. Thereafter, the file information managing unit 103 outputs a response indicating setting completion to the utilization program executing unit 101. If an empty entry is absent, the file information managing unit 103 outputs an error response to the utilization program executing unit 101.

In the case of writing data, the file information managing unit 103 receives identification information on a file and a data write instruction from the utilization program executing unit 101. Then, the file information managing unit 103 specifies an entry number corresponding to the acquired identification information on the file from the file table 61. Subsequently, the file information managing unit 103 acquires a data position from an entry with the specified entry number, and outputs the data position to the data read/write processing unit 102. Thereafter, the file information managing unit 103 updates information, such as an updated date and time, in the specified entry in the file table 61. In addition, the file information managing unit 103 outputs, to the addition instructing unit 151 of the update information managing unit 105, the specified entry number, information on write data, and a write enable signal.

In the case of reading data, the file information managing unit 103 receives identification information on a file and a data read instruction from the utilization program executing unit 101. Then, the file information managing unit 103 specifies an entry number corresponding to the acquired identification information on the file from the file table 61. Subsequently, the file information managing unit 103 acquires a data position from an entry with the specified entry number, and outputs the data position to the data read/write processing unit 102

In the case of deleting a file, the file information managing unit 103 receives identification information on a file and a file deletion instruction from the utilization program executing unit 101. Then, the file information managing unit 103 specifies an entry number corresponding to the acquired identification information on the file from the file table 61. Subsequently, the file information managing unit 103 acquires a data position from an entry with the specified entry number, and outputs the data position to the data read/write processing unit 102. In addition, the file information managing unit 103 deletes information stored in the entry with the specified entry number. Thereafter, the file information managing unit 103 outputs a response indicating process completion to the utilization program executing unit 101.

In the case of reading an attribute, the file information managing unit 103 receives identification information on a file and an attribute read instruction from the utilization program executing unit 101. Then, the file information managing unit 103 specifies an entry number corresponding to the acquired identification information on the file from the file table 61. Subsequently, the file information managing unit 103 acquires a data position from an entry with the specified entry number, and outputs the data position to the attribute reading unit 104 and the update information managing unit 105.

The attribute reading unit 104 is implemented by the CPU 2 and the memory 3 illustrated in FIG. 1. Specifically, a corresponding function is implemented by an operation of the file system 93 in FIG. 2 executed by the CPU 2 and the memory 3.

The attribute reading unit 104 receives an attribute read instruction from the utilization program executing unit 101. Furthermore, the attribute reading unit 104 acquires, from the file information managing unit 103, an entry number of a file whose attribute is to be read from the file information managing unit 103.

If an attribute other than the update attribute is specified as an attribute to be read, the attribute reading unit 104 reads a value of a flag of the specified attribute from the attribute information 611 in the acquired entry. Then, the attribute reading unit 104 outputs the read value of the flag of each attribute to the utilization program executing unit 101.

In contrast, if the update attribute is specified as an attribute to be read, the attribute reading unit 104 acquires a value of the update attribute flag 41 corresponding to the acquired entry in an update detection table 154 of the update information managing unit 105. Subsequently, the attribute reading unit 104 uses the acquired value of the update attribute flag 41 as a value representing the flag of the update attribute stored in the bit 612 of the attribute information 611 in the specified entry. Then, the attribute reading unit 104 outputs the value representing the flag of the update attribute to the utilization program executing unit 101.

The update information managing unit 105 is implemented by the update detection table circuit 4. The update information managing unit 105 includes the addition instructing unit 151, a reset instructing unit 152, a table managing unit 153, and the update detection table 154. In the first embodiment, the addition instructing unit 151 to the update detection table 154 are hardware circuits.

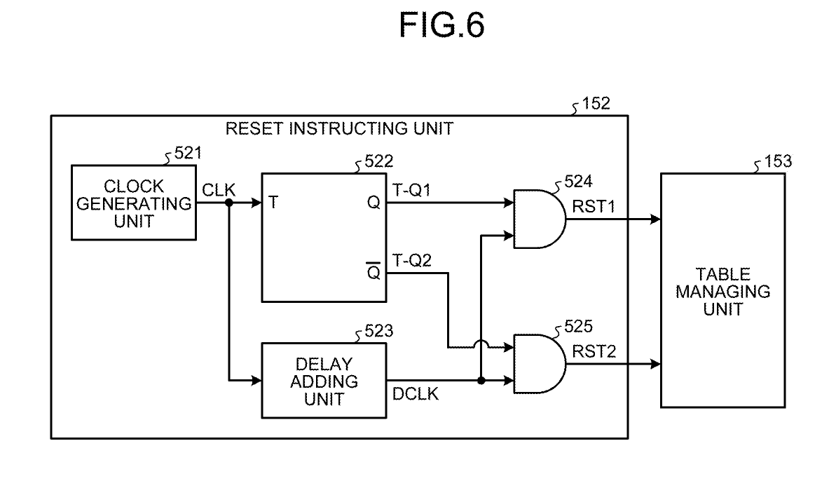

The reset instructing unit 152 outputs, to the table managing unit 153, a first reset signal and a second reset signal that are two reset signals whose cycles are shifted, at a predetermined period. FIG. 6 is a schematic circuit diagram of the reset instructing unit. As illustrated in FIG. 6, the reset instructing unit 152 includes a clock generating unit 521, a T-type flip-flop (FF) 522, a delay adding unit 523, and AND circuits 524 and 525. The reset instructing unit 152 corresponds to an example of a “deletion instructing unit”.

The clock generating unit 521 periodically outputs a clock pulse. For example, the clock generating unit 521 receives a clock from a real time clock (RTC) element included in the information processing apparatus 1, and generates a clock pulse every 24 hours. It is sufficient that a cycle of the clock pulse is shorter than a cycle of the full scan, and it is preferable to determine the cycle of the clock pulse from a balance between a processing load of a virus scan and accuracy of virus detection. If the cycle of the clock pulse is short, the frequency of the virus scan is increased and the accuracy of the virus detection is improved, but the processing load on the information processing apparatus 1 is increased. The clock generating unit 521 outputs the generated clock pulse to the T-type FF 522 and the delay adding unit 523. In FIG. 6, the clock pulse output by the clock generating unit 521 is denoted by “CLK (clock)”.

The T-type FF 522 receives an input of the clock pulse from the clock generating unit 521. The T-type FF 522 outputs a first timing signal and a second timing signal that are two mutually-inverted signals. In FIG. 6, the first timing signal is denoted by “T-Q1”, and the second timing signal is denoted by “T-Q2”. The T-type FF 522 inverts the first timing signal and the second timing signal at a timing at which the clock pulse rises. That is, the first timing signal and the second timing signal are inverted every 24 hours. The T-type FF 522 outputs the first timing signal to the AND circuit 524. Furthermore, the T-type FF 522 outputs the second timing signal to the AND circuit 525.

The delay adding unit 523 is a general element for delaying a signal. The delay adding unit 523 receives an input of the clock pulse from the clock generating unit 521. The delay adding unit 523 generates a delayed clock pulse by adding a predetermined delay to the input clock pulse. For example, the delay adding unit 523 adds a delay of one-fourth of the cycle to the clock pulse to generate the delayed clock pulse. Then, the delay adding unit 523 outputs the delayed clock pulse to the AND circuits 524 and 525. In FIG. 6, the delayed clock pulse is denoted by “DCLK”.

The AND circuit 524 receives an input of the first timing signal from the T-type FF 522. Furthermore, the AND circuit 524 receives an input of the delayed clock pulse from the delay adding unit 523. Subsequently, the AND circuit 524 obtains a logical product of the first timing signal and the delayed clock pulse. Then, the AND circuit 524 outputs a first reset signal with a value of the obtained logical product to the table managing unit 153. In FIG. 6, the first reset signal is denoted by “RST1”. The first reset signal has an interval twice the interval of the clock pulse signal.

The AND circuit 525 receives an input of the second timing signal from the T-type FF 522. Furthermore, the AND circuit 525 receives an input of the delayed clock pulse from the delay adding unit 523. Subsequently, the AND circuit 525 obtains a logical product of the second timing signal and the delayed clock pulse. Then, the AND circuit 525 outputs a second reset signal with a value of the obtained logical product to the table managing unit 153. In FIG. 6, the second reset signal is denoted by “RST2”. The second reset signal has an interval twice the interval of the clock pulse signal.

Incidentally, the first timing signal and the second timing signal are signals, which have cycles twice the interval of the clock pulse and pulse timings of which are shifted by a half cycle from each other. The cycle of each of the first timing signal and the second timing signal is 48 hours. The delayed clock pulse is input every 24 hours. Therefore, a process is repeated such that the AND circuit 524 outputs the first reset signal, the AND circuit 525 outputs the second reset signal after 24 hours since the output of the first reset signal, and the AND circuit 524 outputs the first reset signal after 24 hours since the output of the second reset signal. The first timing signal and the second timing signal are signals for giving timings to reset the update attribute flag 41.

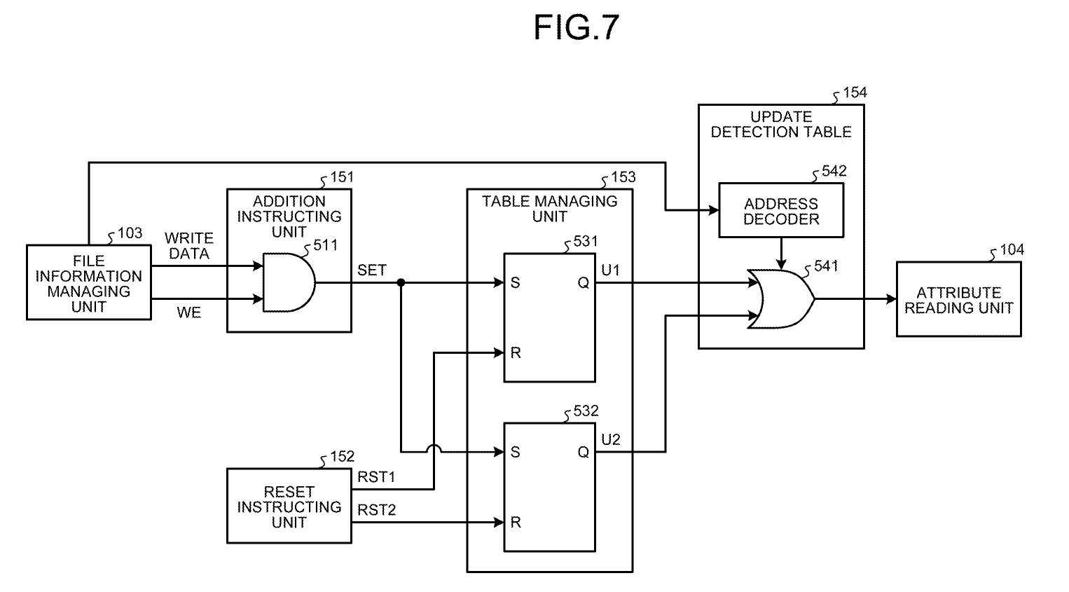

Next, with reference to FIG. 7, the addition instructing unit 151, the table managing unit 153, and the update detection table 154 will be described. FIG. 7 is a schematic circuit diagram illustrating the addition instructing unit, the table managing unit, and the update detection table.

The addition instructing unit 151 outputs, to the table managing unit 153, an instruction to add the update attribute, that is, an instruction to set the update attribute flag 41 to ON. As illustrated in FIG. 7, the addition instructing unit 151 includes an AND circuit 511.

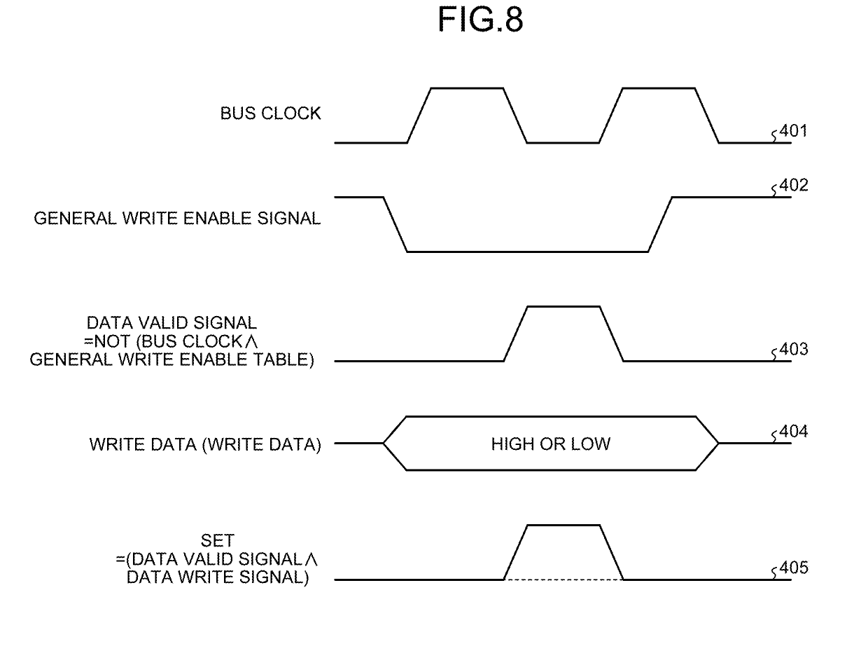

Input and output with respect to the addition instructing unit will be described below with reference to FIG. 8. FIG. 8 is a diagram for explaining input and output with respect to the addition instructing unit. The AND circuit 511 receives an input of write data with a value of High and receives a valid signal of the data, from the file information managing unit 103. The valid signal of the data is a signal indicating a period in which it is ensured that High or Low of the write data is fixed. In the first embodiment, the valid signal is generated as described below. That is, a logical product of a bus clock 401, which is a general signal in a memory access, and a general write enable signal 402 is obtained, and the obtained signal is inverted to obtain a valid signal 403 of data. Then, the AND circuit 511 obtains a logical product of write data 404 and the calculated valid signal 403 of the data. Thereafter, the AND circuit 511 outputs a setting signal 405 with a value of the obtained logical product to the table managing unit 153. In FIGS. 7 and 8, the setting signal is denoted by “SET”.

The table managing unit 153 sets the update attribute flag 41 by using the instruction to set the update attribute flag 41 to ON, which is received from the addition instructing unit 151, and by using the first reset signal and the second reset signal, which are received from the reset instructing unit 152. The table managing unit 153 includes set reset (SR) latches 531 and 532. The table managing unit 153 corresponds to an example of a “managing unit”.

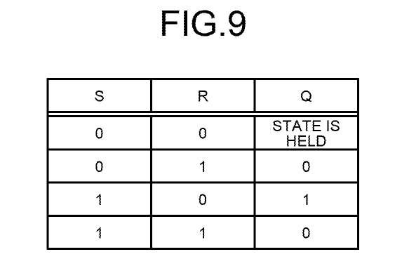

The SR latch 531 receives an input of the setting signal from the addition instructing unit 151 at an input port for set (S). Furthermore, the SR latch 531 receives an input of the first reset signal from the reset instructing unit 152 at an input port for reset (R). Then, the SR latch 531 outputs a first attribute signal in accordance with a truth table illustrated in FIG. 9. FIG. 9 is a diagram of the truth table of the SR latch.

Specifically, if the setting signal and the first reset signal are Low, the SR latch 531 holds the first attribute signal that is being output. Furthermore, if the setting signal is Low and the first reset signal is High, the SR latch 531 outputs, as the first attribute signal, a signal that is set to Low. Moreover, if the setting signal is High and the first reset signal is Low, the SR latch 531 outputs, as the first attribute signal, a signal that is set to High. Furthermore, if the setting signal and the first reset signal are High, the SR latch 531 outputs, as the first attribute signal, a signal that is set to Low. In FIG. 6, the first attribute signal is denoted by “U1”.

The SR latch 532 receives an input of the setting signal from the addition instructing unit 151 at an input port for S. Furthermore, the SR latch 532 receives an input of the second reset signal from the reset instructing unit 152 at an input port for R. Then, similarly to the SR latch 531, the SR latch 532 outputs a second attribute signal in accordance with the truth table illustrated in FIG. 9. In FIG. 6, the second attribute signal is denoted by “U2”.

The update detection table 154 has the same number of the update attribute flags 41 as the number of files. The update detection table 154 sets ON or OFF of the update attribute flag 41 of a file corresponding to an entry number received from the file information managing unit 103, by using the first attribute signal and the second attribute signal received from the table managing unit 153, and outputs the set value to the attribute reading unit 104.

The update detection table 154 includes an address decoder 542 and an OR circuit 541. In FIG. 7, only the OR circuit 541 in a selected state is illustrated; however, the update detection table 154 has the same number of the OR circuits 541 as the number of files. The same number of the OR circuits 541 as the number of files are configured by a single circuit.

The address decoder 542 receives an input of an entry number from the file information managing unit 103. The address decoder 542 converts the acquired entry number to an address representing the OR circuit 541. Thereafter, the address decoder 542 selects the OR circuit 541 represented by the acquired address.

Among the OR circuits 541, the OR circuit 541 selected by the address decoder 542 performs a process as described below. The OR circuit 541 receives an input of the first attribute signal from the SR latch 531. Furthermore, the OR circuit 541 receives an input of the second attribute signal from the SR latch 532. Then, the OR circuit 541 obtains a logical product of the first attribute signal and the second attribute signal, and outputs a value of the obtained logical product as a value of the update attribute flag 41 to the attribute reading unit 104.

Incidentally, as described above, the AND circuit 511 outputs, as the setting signal, the value of the logical product of the write data and the data valid signal. Therefore, for example, a case will be described below in which a malicious program attempts to set the update attribute flag 41 to OFF. In this case, the AND circuit 511 is instructed to write the write data with a value of Low in order to set the update attribute flag 41 to OFF. If the write data has a value of Low, the AND circuit 511 outputs a setting signal having a value of Low. However, in the signal input with respect to the input port for S of the SR latch, there is no operation of changing the output of the AND circuit 511 from High to Low. That is, the update attribute flag 41 is not set to OFF by a program executed by the CPU 2 including the file system 93. Namely, the update information managing unit 105 prevents a program executed by the CPU 2 including the file system 93 from deleting the attribute information. In other words, the update information managing unit 105 sets the update attribute flag 41 to OFF independently of the file system 93, that is, independently of the OS 92.

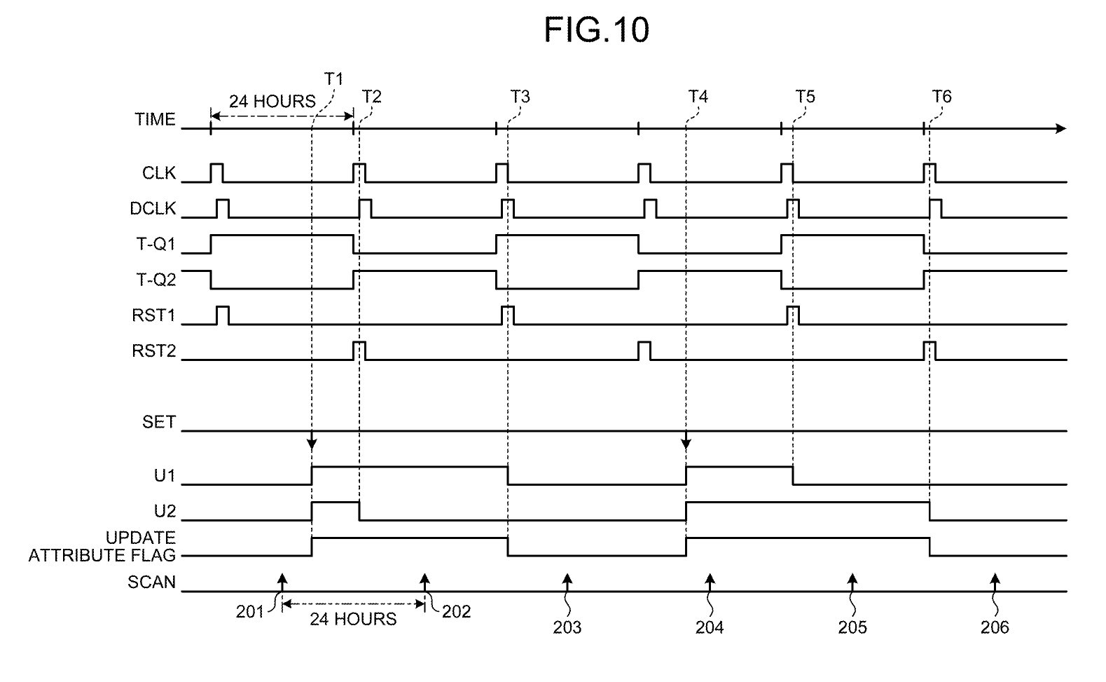

Next, the update detection table 154 and a scan timing will be described with reference to FIG. 10. FIG. 10 is a timing diagram illustrating a relationship between the update detection table and a scan. In FIG. 10, the horizontal axis represents a time course. Each of graphs in FIG. 10 represents a change in a signal of a type indicated on the left end. In the following, a file for which a scan operation is described will be referred to as a target file. Furthermore, a case will be described below in which a differential scan is performed at intervals of 24 hours.

The clock pulse (CLK) is output every 24 hours. In the delayed clock pulse (DCLK), a predetermined delay is added and a pulse timing is shifted.

The first timing signal (T-Q1) is a pulse signal with a cycle twice a cycle from rise to fall of the clock pulse, that is, a cycle of 48 hours. The second timing signal (T-Q2) is an inverted signal of the first timing signal.

The first reset signal (RST1) waits for a value of High at a timing at which the delayed clock pulse becomes High during a period in which the first timing signal remains High. Furthermore, the second reset signal (RST2) waits for a value of High at a timing at which the delayed clock pulse becomes High during a period in which the second timing signal remains High. That is, each of the first reset signal and the second reset signal has an interval twice the interval of the clock pulse, that is, an interval of 48 hours. Moreover, as illustrated in FIG. 10, the first reset signal and the second reset signal are shifted by half cycles of the first timing signal and the second timing signal, that is, shifted by 24 hours.

In the following, a case will be described in which the setting signal (SET) is input to the SR latches 531 and 532 at a time T1 and a time T4. The setting signal is not input before the time T1; therefore, in a scan at a timing 201, a target file is not updated and not subjected to the scan.

The setting signal is input at the time T1, so that the first attribute signal (U1) and the second attribute signal (U2) subsequently shift to states of having values of High.

After the time T1, the second reset signal shifts to a state of having a value of Low at a time T2. Therefore, the second attribute signal output from the SR latch 532 shifts to a state of having a value of Low. However, in this state, the first reset signal continuously has a value of Low, so that the OR circuit 541 as the update attribute flag 41 continuously outputs a value of High. That is, a state in which the update attribute flag 41 of the target file is set to ON is maintained.

At a timing 202, the update attribute flag 41 of the target file is set to ON, so that the target file becomes a scan target and virus detection is performed.

Subsequently, at a time T3, the first reset signal shifts to a state of having a value of Low. Therefore, the first attribute signal output from the SR latch 531 shifts to a state of having a value of Low. In this case, the second reset signal also has a value of Low, so that the OR circuit 541 as the update attribute flag 41 shifts to a value of Low at the time T3. That is, the update attribute flag 41 of the target file is set to an OFF state.

At a timing 203, the update attribute flag 41 of the target file is set to OFF, so that the target file is excluded from scan targets.

Furthermore, at the time T4, the setting signal is input, so that the first attribute signal and the second attribute signal subsequently shift to states of having values of High.

After the time T4, at a timing 204 before both of the first reset signal and the second reset signal reach values of Low, the update attribute flag 41 of the target file is set to ON, so that the target file becomes a scan target and virus detection is performed.

Subsequently, at a time T5, the first reset signal shifts to a state of having a value of Low. Therefore, the first attribute signal output from the SR latch 531 shifts to a state of having a value of Low. However, in this state, the second reset signal continuously has a value of Low, so that the OR circuit 541 as the update attribute flag 41 continuously outputs a value of High. That is, a state in which the update attribute flag 41 of the target file is set to ON is maintained.

At a timing 205, the update attribute flag 41 of the target file is set to ON, so that the target file becomes a scan target and virus detection is performed. That is, in this case, a virus scan is performed twice with respect to single update.

Subsequently, at a time T6, the second reset signal shifts to a state of having a value of Low. Therefore, the second attribute signal output from the SR latch 532 shifts to a state of having a value of Low. In this case, the first reset signal also has a value of Low, so that the OR circuit 541 as the update attribute flag 41 shifts to a value of Low at the time T6. That is, the update attribute flag 41 of the target file is set to an ON state. Consequently, the target file is excluded from scan targets at a subsequent timing 206.

As described above, the update attribute flag 41 is maintained in the ON state at least during a period corresponding to the shift between the cycles of the first reset signal and the second reset signal. In the first embodiment, the update attribute flag 41 is maintained in the ON state at least for 24 hours. Therefore, by reducing a scan timing relative to the period corresponding to the shift between the cycles of the first reset signal and the second reset signal, it becomes possible to reliably scan an updated file. The duration in which the update attribute flag 41 is set to the ON state corresponds to an example of a “predetermined period”.

The period corresponding to the shift between the cycles of the first reset signal and the second reset signal is equal to a half of the cycle of the first timing signal and the second timing signal. Furthermore, the single cycle of the first timing signal and the second timing signal is twice the cycle of the clock pulse. Therefore, the period corresponding to the shift between the cycles of the first reset signal and the second reset signal is equal to the cycle of the clock pulse. In other words, the cycle of the clock pulse gives a period in which the update information on the file is held. Therefore, by reducing the scan timing relative to the cycle of the clock pulse, the virus detection software can reliably scan an updated file without overlooking update of the file.

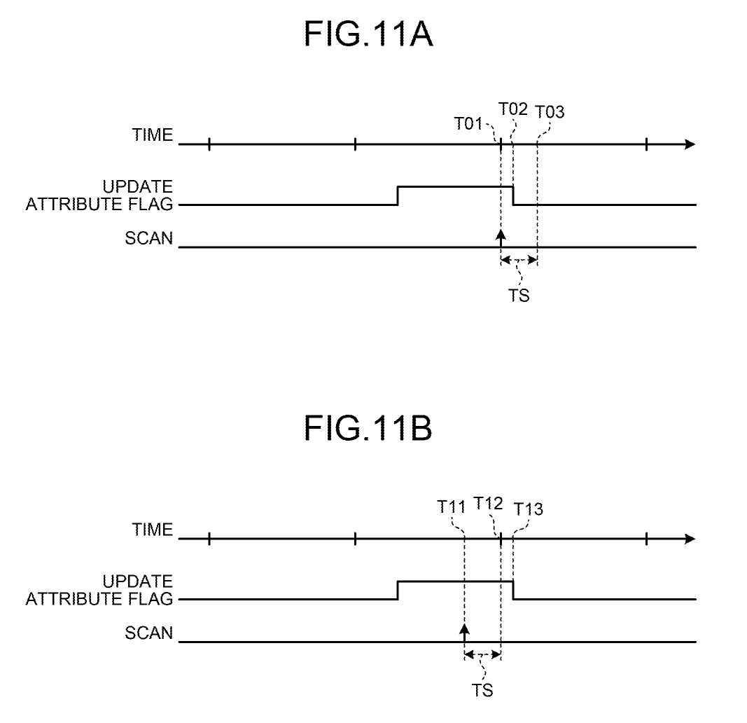

A condition of the scan timing of the virus detection software will be described below with reference to FIGS. 11A and 11B. FIG. 11A is a timing diagram when a timing of setting the update attribute flag to OFF and the scan timing are close to each other. FIG. 11B is a timing diagram when a timing of setting the update attribute flag to OFF and the scan timing are adequately separated from each other. In FIGS. 11A and 11B, the horizontal axes represent a time course. Furthermore, in FIGS. 11A and 11B, the ON/OFF state of the update attribute flag 41 is represented by a combination of the first attribute signal and the second attribute signal.

When the timing of setting the update attribute flag 41 to OFF and the scan timing are close to each other, there is a case that a check is not completely performed depending on an operation period of the virus detection software. For example, as illustrated in FIG. 11A, if a scan is started at a time T01, it is preferable to subject a target file to a scan in a normal situation because the update attribute flag 41 of the target file is set to ON. However, if the operation period of the virus detection software is a period TS and a process is to be terminated at a time T03, the update attribute flag 41 of the target file is set to OFF at a time T02 during the period. If the virus detection software has not completed a check of the update attribute flag 41 of the target file by the time T02, the target file is excluded from scan targets.

Furthermore, as in the first embodiment, if the timing of setting the update attribute flag 41 to OFF is once a day and the scan timing is also once a day, there is a potential that a scan is not completely performed in every scan, so that it may be difficult to reliably perform virus detection.

Therefore, to prevent a risk as described above, it is preferable to set the scan timing such that, as illustrated in FIG. 11B, a time T13 at which the update attribute flag 41 is set to OFF comes after the period TS starting from a time T11, at which an operation of antivirus software is started, to a time T12, at which the operation is terminated. That is, it is preferable to activate the antivirus software a certain time far longer than the period TS before the time T13 at which the update attribute flag 41 is set to OFF. Consequently, it becomes possible to prevent the update attribute flag 41 from being set to OFF during the operation period of the virus detection software, so that it is possible to prevent omission of a scan.

For example, a case will be described below, in which a cycle of setting the update attribute flag 41 to OFF and a cycle of a scan are 24 hours, and a maximum processing time of the antivirus software is 4 hours. In this case, if a time at which the update attribute flag 41 is set to OFF is set to 0:00, it is preferable to set an activation time of the antivirus software to 5:00 or 18:00.

Furthermore, an object of the update information managing unit 105 is to obtain a state in which the update detection table 154 holds a signal at High by a write operation of setting the update attribute flag 41 to ON, that is, by an operation of writing data of High. Furthermore, another object of the update information managing unit 105 is to obtain a state in which the update detection table 154 holds a signal at Low by a reset operation. A general memory shifts to a state of holding data of Low by an operation of writing data of Low, but the update information managing unit 105 does not have this function. Alternatively, the update information managing unit 105 shifts to a state of holding data of Low in the update detection table 154 by a reset signal that is independent of the OS.

Incidentally, if a timing of the operation of writing data of High and a timing of the reset operation overlap each other in the SR latches 531 and 532, a value held in the update detection table 154 may become unstable. Specific reasons will be described below. That is, the update information managing unit 105 according to the first embodiment shifts to the state of holding data of High by using outputs from the SR latches 531 and 532. However, in each of the SR latches 531 and 532, if a timing of inputting a signal at High to the input port for S and a timing of inputting a signal at Low to the input port for R overlap each other, an output becomes unstable, and an error state in which data of High is not output may occur.

Therefore, in the first embodiment, two systems such as the SR latch 531 and the SR latch 532 are arranged, and a logical sum of the latches is used as an output of the update detection table 154 in order to prevent a state in which a value held in the update detection table 154 becomes unstable. That is, even when one of the SR latches 531 and 532 is unstable, the other one of the SR latches 531 and 532 infallibly outputs a value of High. Therefore, by using a logical sum of an output of the SR latch 531 and an output of the SR latch 532 as a value of the update attribute flag 41, the update attribute flag 41 is set to ON when the setting signal is High independently of a reset timing.

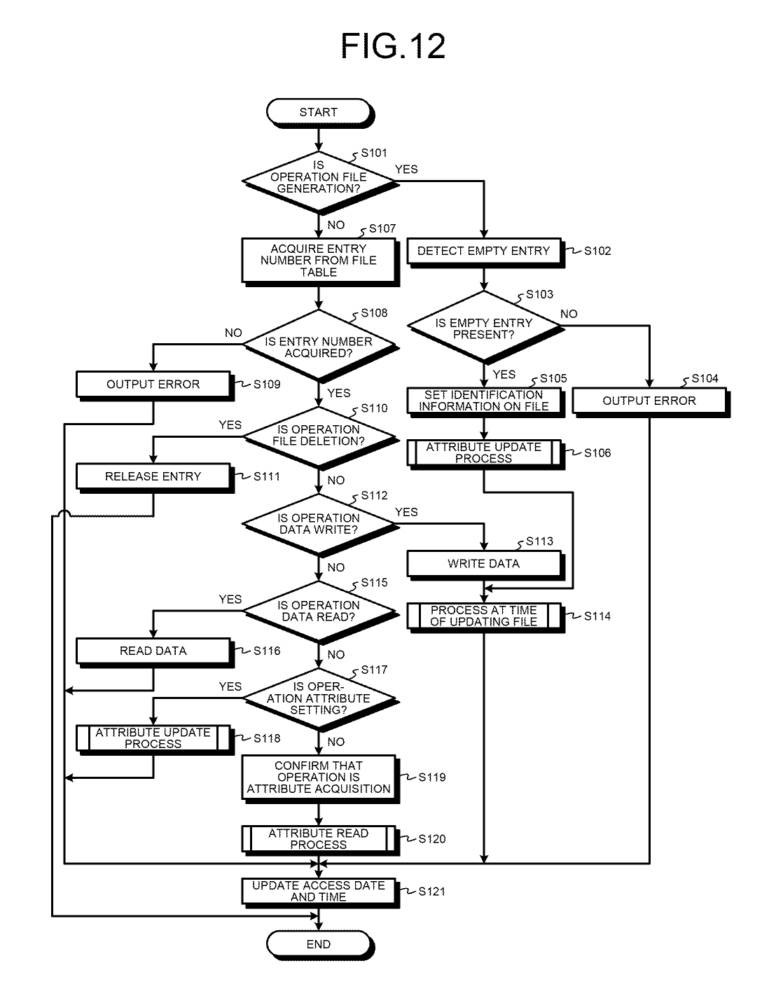

The flow of managing a file by an information system according to the first embodiment will be described below with reference to FIG. 12. FIG. 12 is a flowchart of a file management process. The file management process in FIG. 12 is performed by the file system 93 executed by the CPU 2 and the memory 3. In the following, units illustrated in FIG. 4 corresponding to the file system 93 will be described as the subjects of operations.

The file information managing unit 103 determines whether an operation specified by the utilization program executing unit 101 is file generation (Step S101). If the operation is file generation (YES at Step S101), the file information managing unit 103 detects an empty entry in the file table 61 stored in the storage 6 (Step S102).

Then, the file information managing unit 103 determines whether the empty entry is present in the file table 61 (Step S103). If the empty entry is not present (NO at Step S103), the file information managing unit 103 outputs an error to the utilization program executing unit 101 (Step S104), and the process proceeds to Step S121.

In contrast, if the empty entry is present (YES at Step S103), the file information managing unit 103 sets identification information on a specified file in the empty entry in the file table 61 (Step S105). Furthermore, the file information managing unit 103 performs the attribute update process (Step S106). Thereafter, the file information managing unit 103 causes the process to proceed to Step S114.

In contrast, if the operation is not file generation (NO at Step S101), the file information managing unit 103 acquires, from the file table 61, an entry number corresponding to identification information on a file received from the utilization program executing unit 101 (Step S107).

Then, the file information managing unit 103 determines whether the entry number corresponding to the identification information on the file is acquired (Step S108). If the entry number is not acquired (NO at Step S108), the file information managing unit 103 outputs an error to the utilization program executing unit 101 (Step S109). Thereafter, the process proceeds to Step S121.

In contrast, if the entry number is acquired (YES at Step S108), the file information managing unit 103 acquires a data position from an entry with the acquired entry number, and outputs the data position to the data read/write processing unit 102. Then, the data read/write processing unit 102 and the file information managing unit 103 determine whether the operation specified by the utilization program executing unit 101 is file deletion (Step S110). If the specified operation is file deletion (YES at Step S110), the data read/write processing unit 102 and the file information managing unit 103 release the entry with the specified entry number (Step S111). Specifically, the data read/write processing unit 102 deletes information registered in the entry with the acquired entry number. Furthermore, the file information managing unit 103 deletes the data 62 in the acquired data position in the storage 6. Thereafter, the data read/write processing unit 102 and the file information managing unit 103 end the process.

In contrast, if the specified operation is not file deletion (NO at Step S110), the data read/write processing unit 102 and the file information managing unit 103 determine whether the operation specified by the utilization program executing unit 101 is data write (Step S112). If the specified operation is data write (YES at Step S112), the data read/write processing unit 102 writes the data 62 in the data position in the storage 6 notified by the file information managing unit 103 (Step S113). Furthermore, the file information managing unit 103 performs the process at the time of updating a file (Step S114). Thereafter, the process proceeds to Step S121.

In contrast, if the specified operation is not data write (NO at Step S112), the data read/write processing unit 102 determines whether the operation specified by the utilization program executing unit 101 is data read (Step S115). If the specified operation is the data read (YES at Step S115), the data read/write processing unit 102 reads the data 62 from the data position in the storage 6 notified by the file information managing unit 103 (Step S116). Thereafter, the process proceeds to Step S121.

In contrast, if the specified operation is not data read (NO at Step S115), the file information managing unit 103 determines whether the operation specified by the utilization program executing unit 101 is attribute setting (Step S117). If the specified operation is attribute setting (YES at Step S117), the file information managing unit 103 performs the attribute update process (Step S118). Thereafter, the process proceeds to Step S121.

In contrast, if the specified operation is not attribute setting (NO at Step S117), the attribute reading unit 104 confirms that the operation specified by the utilization program executing unit 101 is attribute acquisition (Step S119). Then, the attribute reading unit 104 performs the attribute read process (Step S120).

Thereafter, the file information managing unit 103 updates an access date and time of the entry with the specified entry number in the file table 61 with a current date and time (Step S121).

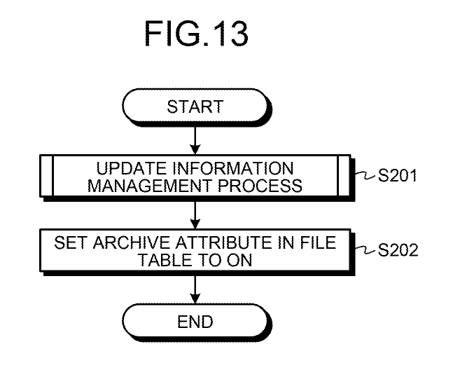

Next, the process at the time of updating a file will be described with reference to FIG. 13. FIG. 13 is a flowchart of the process at the time of updating a file. The flowchart in FIG. 13 corresponds to an example of the process performed at Step S114 in FIG. 12.

The file information managing unit 103 performs an update information management process (Step S201).

Subsequently, the file information managing unit 103 sets the archive attribute of an entry in the file table 61 corresponding to the identification information specified by the utilization program executing unit 101 to ON (Step S202).

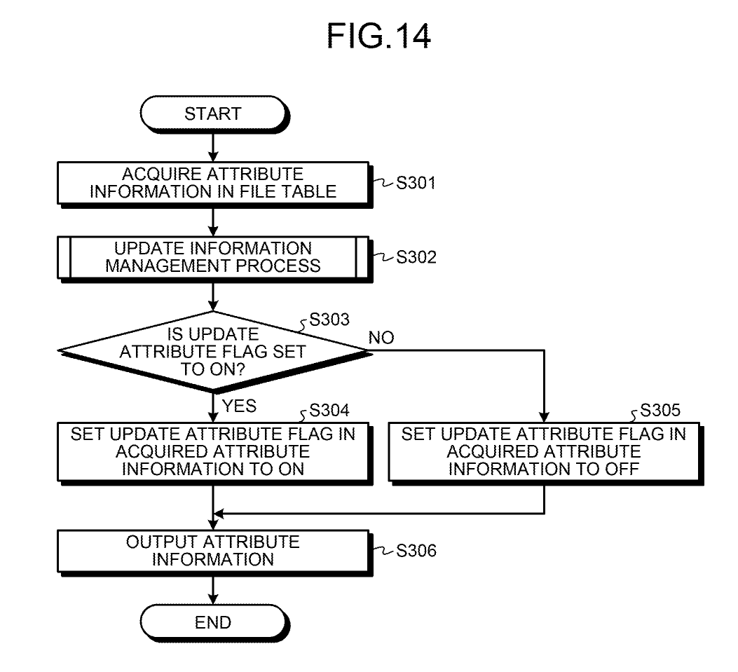

Next, the attribute read process will be described with reference to FIG. 14. FIG. 14 is a flowchart of the attribute read process. The flowchart in FIG. 14 corresponds to an example of the process performed at Step S120 in FIG. 12.

The attribute reading unit 104 acquires attribute information in the file table 61 corresponding to the identification information specified by the utilization program executing unit 101 (Step S301).

Subsequently, the attribute reading unit 104 performs the update information management process (Step S302). Then, the attribute reading unit 104 acquires information on ON or OFF of the update attribute flag 41 from the update information managing unit 105.

The attribute reading unit 104 determines whether the update attribute flag 41 acquired from the update information managing unit 105 is set to ON (Step S303). If the update attribute flag 41 acquired from the update information managing unit 105 is set to ON (YES at Step S303), the attribute reading unit 104 sets the update attribute flag 41 in the attribute information acquired from the file table 61 to ON (Step S304).

In contrast, if the update attribute flag 41 acquired from the update information managing unit 105 is set to OFF (NO at Step S303), the attribute reading unit 104 sets the update attribute flag 41 in the attribute information acquired from the file table 61 to OFF (Step S305).

Thereafter, the attribute reading unit 104 outputs the attribute information to the utilization program executing unit 101 (Step S306).

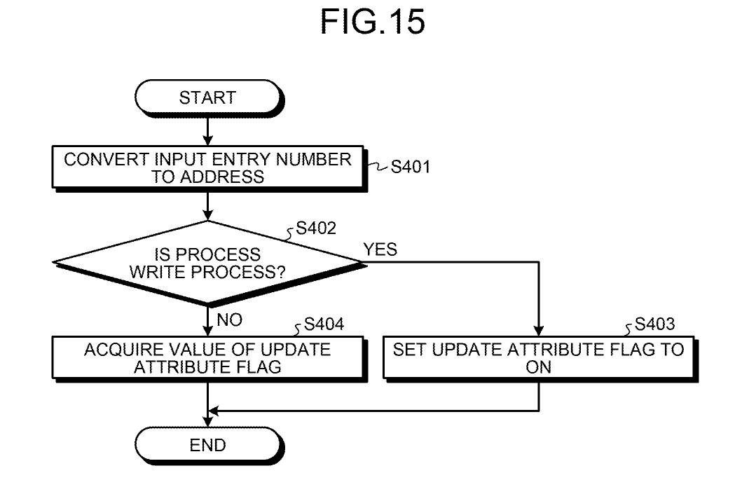

Next, the update information management process will be described with reference to FIG. 15. FIG. 15 is a flowchart of the update information management process. The flowchart in FIG. 15 corresponds to an example of the processes performed at Step S201 in FIG. 13 and Step S302 in FIG. 14. Incidentally, the update information management process in FIG. 15 is performed by the device driver 94, which is executed by the CPU 2 and the memory 3 to access update information, and by the update detection table circuit 4. In the following, units illustrated in FIG. 4 corresponding to the device driver 94 for accessing the update information and corresponding to a circuit as the update information managing unit 105 will be described as the subjects of operations.

The update detection table 154 receives an input of the entry number from the file information managing unit 103. Then, the update detection table 154 converts the acquired entry number to an address representing any of the OR circuits 541 included in the update detection table 154 (Step S401).

Subsequently, the file information managing unit 103 and the attribute reading unit 104 determines whether a process is an attribute write process (Step S402).

If the process is the attribute write process (YES at Step S402), the file information managing unit 103 outputs a write enable signal and write data to the update information managing unit 105. The update information managing unit 105 sets a value of the OR circuit 541 corresponding to the entry number to ON (Step S403).

In contrast, if the process is not the attribute write process (NO at Step S402), the attribute reading unit 104 acquires a value of the update attribute flag 41 from the update detection table 154 (Step S404).

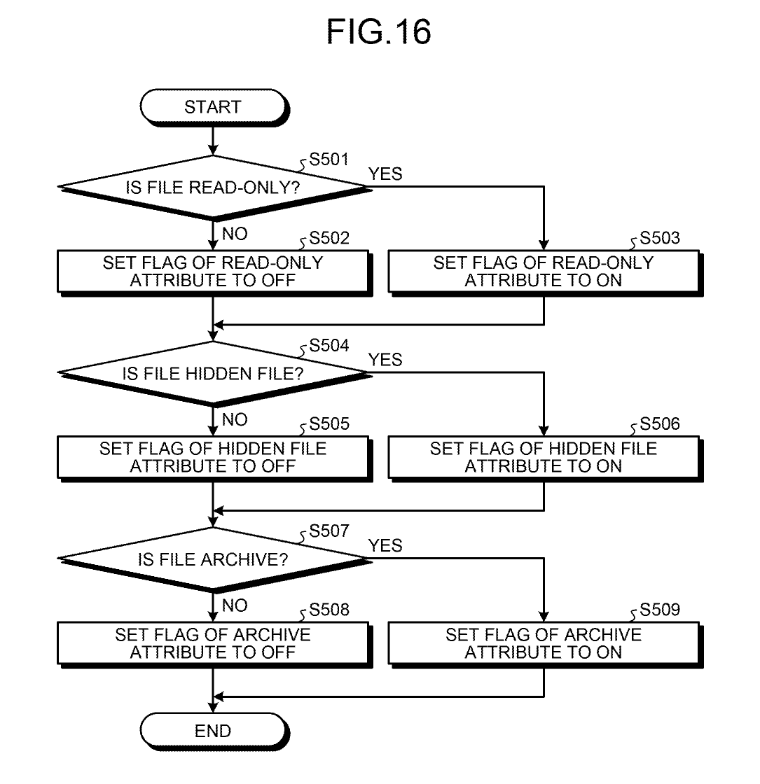

Next, the attribute update process will be described with reference to FIG. 16. FIG. 16 is a flowchart of the attribute update process. The flowchart in FIG. 16 corresponds to an example of the processes performed at Steps S106 and S118 in FIG. 12.

The file information managing unit 103 acquires an entry number corresponding to identification information specified by the utilization program executing unit 101. Then, the file information managing unit 103 determines whether the specified file is read-only (Step S501). If the specified file is not read-only (NO at Step S501), the file information managing unit 103 sets a flag of the read-only attribute of the entry with the acquired entry number to OFF (Step S502). In contrast, if the specified file is read-only (YES at Step S501), the file information managing unit 103 sets the flag of the read-only attribute of the entry with the acquired entry number to ON (Step S503).

Subsequently, the file information managing unit 103 determines whether the specified file is a hidden file (Step S504). If the specified file is not a hidden file (NO at Step S504), the file information managing unit 103 sets a flag of the hidden file attribute of the entry with the acquired entry number to OFF (Step S505). In contrast, if the specified file is a hidden file (YES at Step S504), the file information managing unit 103 sets the flag of the hidden file attribute of the entry with the acquired entry number to ON (Step S506).

Subsequently, the file information managing unit 103 determines whether the specified file is an archive (Step S507). If the specified file is not an archive (NO at Step S507), the file information managing unit 103 sets a flag of the archive attribute of the entry with the acquired entry number to OFF (Step S508). In contrast, if the specified file is an archive (YES at Step S507), the file information managing unit 103 sets the flag of the archive attribute of the entry with the acquired entry number to ON (Step S509).

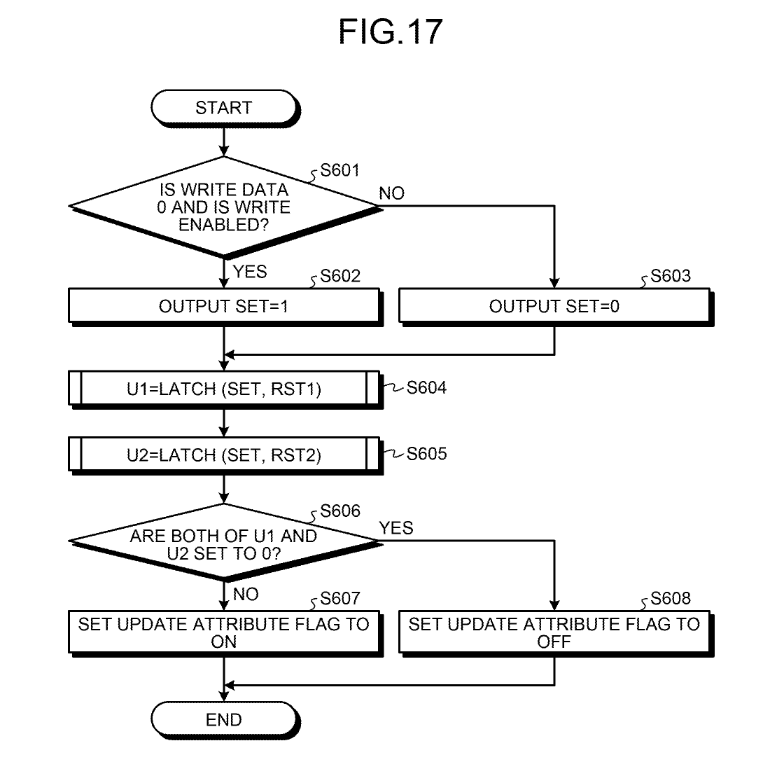

Next, a process of setting the update attribute flag 41 by the update information managing unit 105 will be described with reference to FIG. 17. FIG. 17 is a flowchart of the process of setting the update attribute flag by the update information managing unit. In the following description, it is assumed that a value of a signal at High is 1 and a value of a signal at Low is 0.

The AND circuit 511 of the addition instructing unit 151 determines whether write data is 1 and write is enabled, that is, a data valid signal is input (Step S601). If the write data is 1 and write is enabled (YES at Step S601), the AND circuit 511 outputs a setting signal (SET) with a value of 1 to the SR latches 531 and 532 of the table managing unit 153 (Step S602).

In contrast, if the write data is 0 or write is disabled (NO at Step S601), the AND circuit 511 outputs the setting signal (SET) with a value of 0 to the SR latches 531 and 532 of the table managing unit 153 (Step S603).

The SR latch 531 receives an input of the setting signal (SET) from the AND circuit 511. Furthermore, the SR latch 531 receives an input of the first reset signal (RST1) from the reset instructing unit 152. Then, a process of generating the first attribute signal (U1) based on the setting signal (SET) and the first reset signal (RST1) is performed, and the generated first attribute signal (U1) is output to the OR circuit 541 of the update detection table 154 (Step S604). Incidentally, “latch(S, R)” in FIG. 17 indicates a process of generating an output by using a signal denoted by S in the parenthesis, which represents a signal input to the input port for S, and a signal denoted by R in the parenthesis, which represents a signal input to the input port for R, and outputting the output.

The SR latch 532 receives an input of the setting signal (SET) from the AND circuit 511. Furthermore, the SR latch 532 receives an input of the second reset signal (RST2) from the reset instructing unit 152. Then, a process of generating the second attribute signal (U2) based on the setting signal (SET) and the second reset signal (RST2) is performed, and the generated second attribute signal (U2) is output to the OR circuit 541 of the update detection table 154 (Step S605).

The OR circuit 541 determines whether both of the first attribute signal (U1) and the second attribute signal (U2) are set to 0 (Step S606). If one of the first attribute signal (U1) and the second attribute signal (U2) is set to 1 (NO at Step S606), the OR circuit 541 outputs 1 as the value of the update attribute flag 41, and sets the update attribute flag 41 to ON (Step S607).

In contrast, if both of the first attribute signal (U1) and the second attribute signal (U2) are set to 0 (YES at Step S606), the OR circuit 541 outputs 0 as the value of the update attribute flag 41, and sets the update attribute flag 41 to OFF (Step S608).

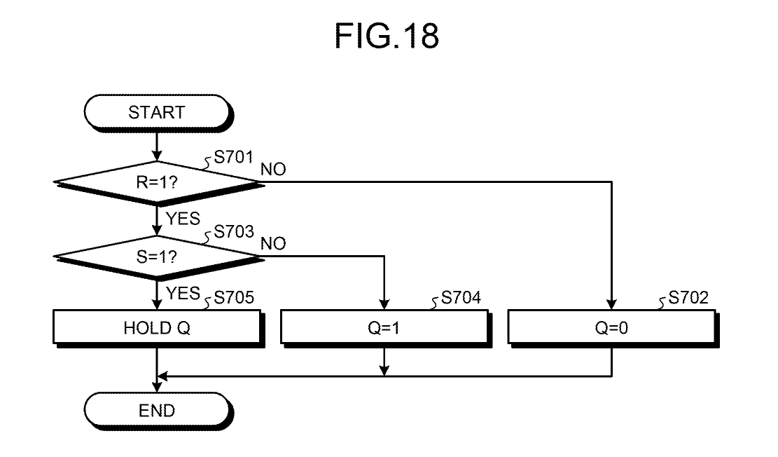

Next, an output determination process performed by the SR latches 531 and 532 will be descried with reference to FIG. 18. FIG. 18 is a flowchart of the output determination process performed by the SR latch. In the following, the SR latches 531 and 532 are not distinguished, and collectively referred to as an “SR latch 530”. Furthermore, in the following, a signal input to the input port for S is denoted by “S”, and a signal input to the input port for R is denoted by “R”. Moreover, an output of the SR latch 530 is denoted by “Q”.

The SR latch 530 determines whether “1” is input to the input port for R (Step S701). If “1” is not input to the input port for R (NO at Step S701), the SR latch 530 outputs 0 (Step S702).

In contrast, if “1” is input to the input port for R (YES at Step S701), the SR latch 530 determines whether “1” is input to the input port for S (Step S703). If “1” is not input to the input port for S (NO at Step S703), the SR latch 530 outputs 1 (Step S704).

In contrast, if “1” is input to the input port for S (YES at Step S703), the SR latch 530 holds a value of the output (Step S705).

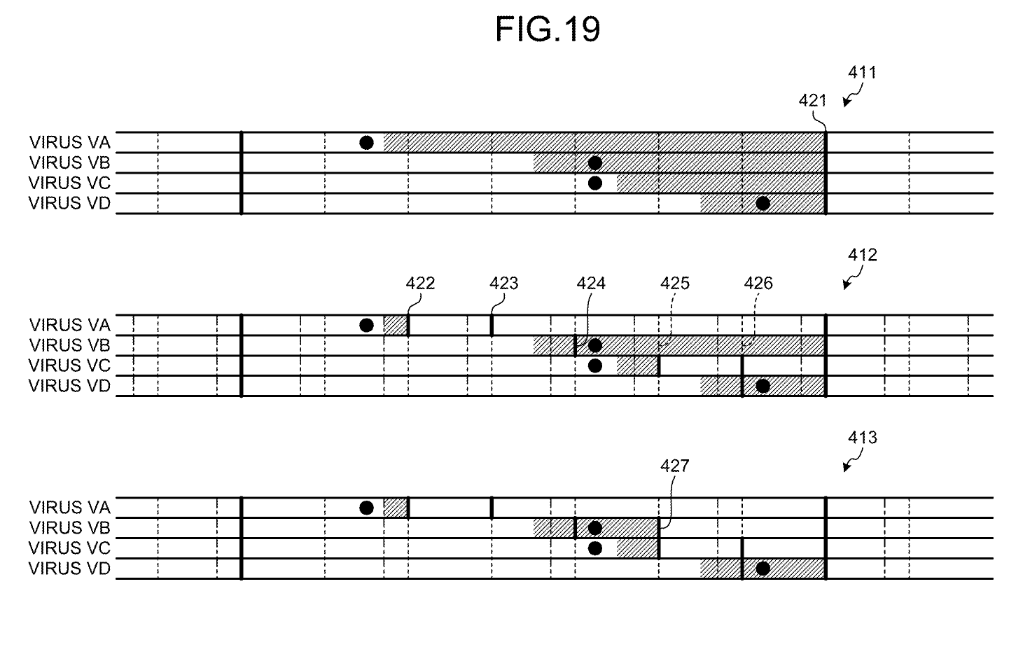

Next, an effect of virus detection using the information processing apparatus according to the first embodiment will be described with reference to FIG. 19. FIG. 19 is a diagram for explaining the effect of the virus detection using the information processing apparatus according to the first embodiment.

A graph 411 represents a state of cleaning a virus by performing only a full scan once a week. A graph 412 represents a state of cleaning a virus by using the information processing apparatus according to the first embodiment when the update attribute flag 41 is ensured to be in the ON state for 24 hours and a differential scan is performed every 24 hours. A graph 413 represents a state of cleaning a virus by using the information processing apparatus according to the first embodiment when the update attribute flag 41 is ensured to be in the ON state for 48 hours and a differential scan is performed every 24 hours. Furthermore, in the graphs 412 and 413, a reset signal is output at timings indicated by chain lines. That is, in the graphs 412 and 413, the update attribute flag 41 is set to OFF at the second chain line after invasion of a virus.

Furthermore, bold vertical axes indicate execution of scans. Black circles indicate timings to obtain a pattern corresponding to each virus. Moreover, it is assumed that invasion of a virus has occurred due to update of a file.

In the graphs 411 to 413, the horizontal axes represent time. The scale of the horizontal axes is in units of 24 hours. Rows of each of the graphs 411 to 413 in the vertical direction represent, from the top, a state in which a virus VA has entered, a state in which a virus VB has entered, a state in which a virus VC has entered, and a state in which a virus VD has entered. Plain areas represent a state in which a virus has not entered. Colored areas represent a state in which a virus has entered. In all of the graphs 411 to 413, the viruses VA to VD entered at the same timings.

If only a full scan is performed, as indicated by the graph 411, all of files are scanned at a timing 421 once a week. In this case, the information processing apparatus 1 obtains patterns of the viruses VA to VD before the timing 421, so that it is possible to clean all of the viruses VA to VD. However, periods in which the viruses VA to VD entered are long.

In contrast, if the ON state of the flag is ensured for 24 hours and a differential scan is performed every 24 hours, as indicated by the graph 412, the virus VA is cleaned at a timing 422 next to a timing of invasion of the virus VA. However, the update attribute flag 41 is maintained in the ON state until a next scan timing 423. Therefore, at the timing 423, the file from which a virus has already been cleaned is scanned again. Furthermore, in a scan at a timing 424 after a timing of invasion of the virus VB, a pattern of the virus VB is not yet obtained, and therefore, it is difficult to clean the virus VB. Moreover, at a timing 425, two chain lines have already been passed, so that the update attribute flag 41 is set to OFF. Therefore, at the timing 425 and a timing 426, a differential scan is not performed and the virus VB is not cleaned. The virus VB is cleaned by a full scan after a wait. Furthermore, the virus VC is cleaned by a scan at the timing 425 immediately after invasion. However, at a later time, the already-scanned file is scanned again. Moreover, the virus VD is not cleaned by a scan immediately after invasion because a pattern of the virus VD is not yet obtained, and the virus VD is cleaned by the full scan.

In contrast, if the ON state of the flag is ensured for 48 hours and a differential scan is performed every 24 hours, as indicated by the graph 413, the viruses VA, VC and VD are in the same states as in the case where the ON state of the flag is ensured for 24 hours. In contrast, as for the virus VB, the update attribute flag 41 is maintained in the ON state at a timing 427, and is therefore cleaned by a scan.

As described above, by performing a differential scan between full scans, it becomes possible to promptly clean a virus and reduce a risk as compared to a case where only the full scan is performed. In addition, the differential scan can be completed with a lower load and a shorter time as compared to the full scan, so that it is possible to reduce the influence on other processes performed by the information processing apparatus 1.

Furthermore, by increasing the duration in which the update attribute flag 41 is in the ON state, it is possible to improve the probability of virus detection. In contrast, by reducing the duration in which the update attribute flag 41 is in the ON state, it is possible to prevent repetition of a scan on a file from which a virus is already cleaned, so that it becomes possible to reduce a processing load. As described above, it is preferable to determine the duration in which the update attribute flag 41 is in the ON state by taking into account the risk and the processing load. Moreover, as described above, the duration in which the update attribute flag 41 is in the ON state can be determined by the cycle of the clock pulse.

Incidentally, the duration in which the update attribute flag 41 is in the ON state does not have a relation with a scan timing, and this results in redundancy such that a single file is scanned a number of times, similarly to the scans for the virus VA in the graphs 412 and 413. In this case, for example, if it is assumed that the number of files updated by the information processing apparatus 1 in one day is 939, and the total number of files is 136,577, the ratio of the updated files to the number of the files stored in the storage 6 is 0.7%. In this case, the number of files to be scanned by a differential scan also corresponds to 0.7%. For example, if the amount of files corresponds to a full scan that takes 2 hours, a time taken for a differential scan in one day is shorter than 1 minute. Therefore, even if the number of scans is doubled, the influence of the differential scan is small and a scan time can be adequately reduced. Therefore, even when the differential scan has the redundancy as described above, the scan time can be adequately reduced.

As described above, in the information processing apparatus according to the first embodiment, the update attribute flag indicating that a file is updated is set to ON when the file is updated, deletion of the file from software is prevented, and the update attribute flag is set to OFF after a lapse of a predetermined period. Then, a process is performed on only a file for which the update attribute flag is set to ON. In this manner, the update attribute flag is not set to OFF by the software, so that it is possible to reliably perform a process on the updated file.

In particular, in the case of a virus scan, it is possible to indicate an updated file for a predetermined period without manipulation by a virus. Furthermore, the information processing apparatus according to the first embodiment can perform virus detection in a short time and with high reliability by performing a differential scan on a file for which the update attribute flag is set to ON. Moreover, by periodically performing a differential scan between full scans, it is possible to reliably and promptly clean a virus and reduce a risk.

### [b] Second Embodiment

A second embodiment will be described below. An information processing apparatus according to the second embodiment is different from that of the first embodiment in that it can change the cycle of the clock pulse. The information processing apparatus according to the second embodiment is also illustrated in FIGS. 4, 6, and 7. In the following description, explanation of the same functions as those of the units of the first embodiment will be omitted.

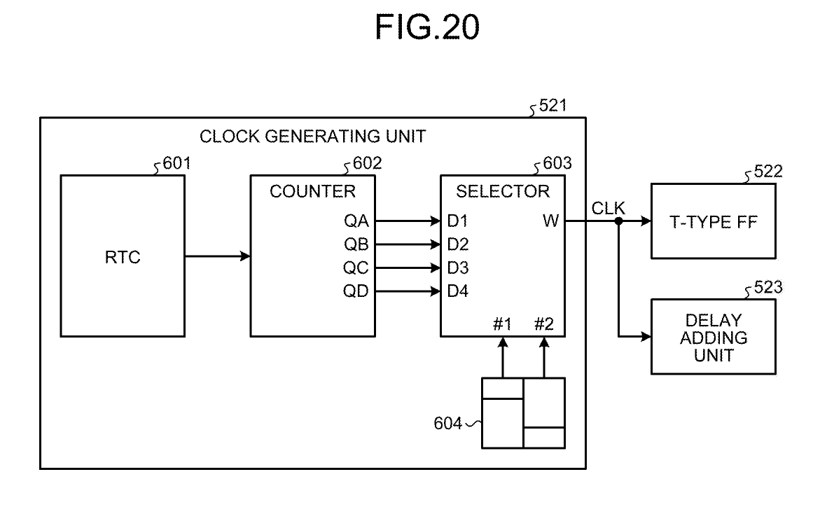

FIG. 20 is a schematic circuit diagram of a clock generating unit according to the second embodiment. As illustrated in FIG. 20, the clock generating unit 521 includes an RTC 601, a counter 602, a selector 603, and a dip switch 604.

The dip switch 604 provides two-bit information to the selector 603 by, for example, an operation on a switch performed by an operator. Specifically, the dip switch 604 inputs 0 or 1 as a signal #1 and inputs 0 or 1 as a signal #2 to the selector 603 in accordance with an instruction from the operator. Therefore, the dip switch 604 inputs four kinds of signals to the selector 603.

The RTC 601 periodically outputs a pulse signal to the counter 602. For example, the RTC 601 outputs a pulse signal to the counter 602 every 24 hours.

The counter 602 includes output ports QA to QD. The counter 602 periodically receives an input of a pulse signal from the RTC 601. Then, the counter 602 counts the pulse signals and outputs pulse signals from the respective output ports QA to QD at different periodic timings corresponding to the number of counts. In the following, the pulse signals output from the output ports QA to QD are described as signals QA to QD, respectively.

For example, the counter 602 outputs the signals QA to QD as described below. The counter 602 outputs the signal QA every count of a pulse signal. Furthermore, the counter 602 outputs a single QB every two counts of pulse signals. Moreover, the counter 602 outputs the signal QC every three counts of pulse signals. Furthermore, the counter 602 outputs the signal QD every four counts of pulse signals. Therefore, the counter 602 outputs the signal QA with a cycle of 24 hours, outputs the signal QB with a cycle of 48 hours, outputs the signal QC with a cycle of 72 hours, and outputs the signal QD with a cycle of 96 hours.

The selector 603 includes input ports D1 to D4. The selector 603 stores, in advance, which of signals input to the input ports D1 to D4 is to be selected in accordance with a signal input from the dip switch 604.

The selector 603 receives inputs of the signals QA to QD at the respective input ports D1 to D4. Subsequently, the selector 603 selects one of the signals input to the input ports D1 to D4 in accordance with a signal input from the dip switch 604. Then, the selector 603 outputs the selected signal as a clock pulse to the T-type FF 522 and the delay adding unit 523.

Incidentally, while a signal to be used as a clock pulse is selected from the four kinds of signals in the second embodiment, the number of signals to be used as selection candidates is not specifically limited.

In this manner, in the information processing apparatus 1 according to the second embodiment, the cycle of the clock pulse is changed by an operation on the dip switch 604. That is, an operator can change a duration in which the update attribute flag 41 is in the ON state by operating the dip switch 604.

As described above, the information processing apparatus according to the second embodiment can change a period in which the update attribute flag is set to ON, by operating the dip switch, so that it is possible to easily implement a differential scan corresponding to a system environment.

Incidentally, while a virus scan using the update attribute has been described in the above-described embodiments, the functions according to the embodiments may be used for other processes using the update attribute. For example, a process will be described below as an example of application to other utilization programs. As one example, the mechanism described in the embodiments can coexist with backup software because the mechanism does not use the archive attribute, and therefore can be used for a program of a backup system. Furthermore, by applying the mechanism to a program for processing only the latest file, the program can perform a process while omitting a date check.

Moreover, while the duration in which the update attribute flag 41 is in the ON state is determined by the time in the second embodiment, it is not limited thereto. For example, various switches and a signal input of a sensor may be used together. For example, the duration in which the update attribute flag 41 is in the ON state may be determined in combination with information on a temperature sensor, in addition to the information from the dip switch. For example, if a high load is applied, a temperature inside the information processing apparatus is increased. Therefore, if a temperature measured by the temperature sensor is higher than a predetermined value, it may be possible to reduce a duration of the state in which the update attribute flag 41 is set to ON, in order to reduce the frequency of scan. Furthermore, the update detection table circuit 4 may be configured with only hardware, may be configured by using firmware using a read only memory (ROM), or may be configured by using a dedicated computer.

According to an embodiment of the information processing apparatus and a method of controlling the information processing apparatus of the disclosed technology, it is possible to reliably perform a process on an updated file.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a processor and a memory,
wherein the processor,
when specific data is updated, adds update information to the specific data, prevents a predetermined program from deleting the update information, and deletes the update information added to the specific data when a predetermined condition of the specific data is satisfied; and,
when the update information is added, performs a predetermined process on the specific data.

2. The information processing apparatus according to claim 1, wherein the processor deletes the update information from the specific data after a lapse of a predetermined period since addition of the update information to the specific data.

3. The information processing apparatus according to claim 1, wherein the processor,
when the specific data is updated, receives an instruction from the predetermined program and gives an instruction to add the update information to the specific data;
when the predetermined condition of the specific data is satisfied, gives an instruction to delete the update information from the specific data; and
manages the update information of the specific data based on the instructions.

4. The information processing apparatus according to claim 3, wherein the processor determines whether the predetermined condition is satisfied on the basis of a pulse signal that is periodically generated.

5. The information processing apparatus according to claim 3, wherein the processor,
when instructing to delete the update information, deletes the update information added to the specific data,
when not instructing to delete the update information and when instructing to add the update information, adds the update information to the specific data, and,
when not instructing to delete the update information and when not instructing to add the update information, maintains a state of the update information with respect to the specific data.

6. The information processing apparatus according to claim 1, wherein the processor performs an examination process on the specific data.

7. A method of controlling an information processing apparatus, comprising:
adding update information to specific data when the specific data is updated;
preventing a predetermined program from deleting the update information;
deleting the update information added to the specific data when a predetermined condition of the specific data is satisfied; and
performing a predetermined process on the specific data when the update information is added.
